(19) United States
(12) Patent Application Publication
(10) Pub. No.: US 2003/0115121 A1
(43) Pub. Date: Jun. 19, 2003

(54) Method, signal, system, software and user interface for increasing the effectiveness of a supply and demand driven network site

(76) Inventors: Neil Bremner, Houston, TX (US); Mark Marlow, Cedar Park, TX (US)

Correspondence Address: SIMON, GALASSO & FRANTZ PLC., P.O. Box 26503, Austin, TX, 78755-0503, US

(21) Appl. No.: 10/279,472

(22) Filed: Oct. 24, 2002

Related U.S. Application Data
(63) Continuation of application No. 09/287,830, filed on Apr. 7, 1999, now abandoned.

(51) Int. Cl. G06F 17/60

(52) U.S. Cl. 705/35

(57) ABSTRACT

A signal, system, software, user interface, and method to increase effectiveness of a networked site. The method monitors activity associated with the networked site, and compares this monitored activity with an acceptable level of activity, determined by the method, associated with the networked site. The method is further configured to automatically adjust characteristics associated with the networked site such that the monitored activity associated with the networked site approaches the acceptable activity level associated with the networked site. The networked site can be enabled for electronic commerce activities or a myriad of other activities.

### CROSS REFERENCE TO RELATED APPLICATIONS

This application claims benefit under 35 U.S.C. §120 of U.S. patent application Ser. No. 09/287,830, entitled Method, Signal, System, Software And User Interface For Increasing The Effectiveness Of A Supply And Demand Driven Network Site, which was filed on Apr. 7, 1999.

### FIELD OF THE INVENTION

The present invention relates generally to information networks and more particularly to information network sites configured for electronic commerce.

### BACKGROUND OF THE INVENTION

With the proliferation of the Internet has come a myriad of new business opportunities. These new business opportunities are not only directed to selling products or services but also to attracting the attention of as many Internet users as possible to a particular network site or web site. A network site, or web site, is a group of related Hypertext Markup Language (HTML) documents and associated files, scripts, and databases accessed with the utilization of software, programs, or applications known as a web browsers. Web sites typically consist of intertwined web pages. When an Internet user accesses a web site, it is commonly referred to as a hit or a visit.

The first step towards effectively selling products or services utilizing electronic communication is to make consumers aware of those products or services. Once a consumer has been made aware of those products or services, it is up to the “marketing minds” of the business offering those products or services to price those products or services at a price that appeals to the consumer. The goal of these “marketing minds” is to influence the consumer in such a way that the consumer feels he/she is getting a bargain when taking advantage of the product or service. As one can imagine, there is an enormous number of factors to be considered and evaluated for the effective selling of products or services utilizing electronic communication.

For example, a product or services marketer might be interested in determining how many consumers have seen advertisements for their products or services offered for sale. Further, of those consumers that have seen a particular marketer's products or services advertised, that particular product or services marketer might also desire to know how many of those consumers actually purchased those products or services. To gather more detail about consumers, a marketer may also desire to determine what common characteristics of products or services stimulate purchases by consumers or how does price sensitivity rate as a characteristic. For example, is the common characteristic of the products or services purchased that their: prices are under a certain dollar amount? a certain color purchased? a particular time of day? a particular day of the week? etc. As one can see, it is easy to become overwhelmed with the reasons of why, how, when, etc., a particular product or service sells or does not sell. Therefore, it would be advantageous to have a supply and demand driven method to automatically monitor the sales of products and services, track characteristics associated with those products or services, and to further adjust those characteristics until an acceptable sales volume and an acceptable level of profitability are achieved.

Many existing web sites are capable of offering and selling products or services to consumers. Some web sites show only an advertisement consisting only of an image and a description of the product or service for sale. Other web sites facilitate bidding wars, acting as auction houses that allow consumers and marketers to negotiate until a deal, or price, suitable to both parties is reached. One limitation of web sites which provide only advertisements is their inherent inability to maximize utilization of a web site by only providing either a static advertisement or by interchanging a limited set of different advertisements in a display. The “auction house” style of Internet web site also contains limitations. One such limitation is the need for both the consumer and the marketer to continuously monitor the moves of the other such that negotiation proceeds at a timely pace. It would be much easier on the marketer to provide a web site that automatically provided a product or service priced according to supply, demand, and a pricing scheme deemed appropriate by the marketer.

What is needed is a method, signal, system, software, and user interface configured to increase the effectiveness of a network location, or web site. The goal of the web site can be to attract the attention of Internet users, or the goal of the web site can be the selling of products or services to consumers. By implementing an automated method capable of monitoring the myriad of characteristics that attract an Internet user to a particular web site and further capable of automatically adjusting those same characteristics such that the effectiveness of the web site is increased, marketers of products or services, as well as similar advertisers, will be able to develop low maintenance, highly effective presentations which will maximize utilization of their web site.

### SUMMARY OF THE INVENTION

Accordingly, the present invention provides a method to increase effectiveness of a networked site comprising the steps of maintaining at least one user selectable item on a network site wherein the user selectable item has at least one characteristic, monitoring activity associated with the network site, and automatically adjusting the at least one characteristic in response to,the step of monitoring activity associated with the network site such that a change in activity associated with the network site can be achieved.

The present invention also provides a computer readable medium tangibly embodying a program of instructions implementing a method to increase effectiveness of a networked site comprising the steps of maintaining at least one user selectable item on a network site, the user selectable item having at least one characteristic, monitoring activity associated with the network site, and automatically adjusting the at least one characteristic in response to the step of monitoring activity associated with the network site such that a change in activity associated with the network site can be achieved.

The present invention further provides a signal embodied in a propagation medium configured to increase effectiveness of a networked site comprising at least one instruction configured to maintain at least one user selectable item on a network site, the user selectable item having at least one characteristic, at least one instruction configured to monitor activity associated with the network site, and at least one instruction configured to automatically adjust the at least one characteristic in response to the at least one instruction configured to monitor activity associated with the network site such that a change in activity associated with the network site can be achieved.

The present invention also provides a user interface configured to maintain at least one user selectable item on a network site, the user selectable item having at least one characteristic. The user interface is further configured to monitor activity associated with the network site, as well as automatically adjust the at least one characteristic in response to the monitored activity associated with the network site such that a change in activity associated with the network site can be achieved.

The present invention further provides an information handling system comprising at least one processor, memory operably associated with the processor, at least one communications adapter operably associated with the processor and the memory, and a user interface configured to maintain at least one user selectable item on a network site, the user selectable item having at least one characteristic, monitor activity associated with the network site, and automatically adjust the at least one characteristic in response to the monitored activity associated with the network site such that a change in activity associated with the network site can be achieved.

It is an object of the present invention to increase the effectiveness of a network site.

It is a further object of the present invention to monitor activity associated with a network site.

It is another object of the present invention to determine an acceptable level of activity associated with a network site.

It is yet another object of the present invention to compare the level of monitored activity associated with a network site to the acceptable level of activity associated with the network site and to further adjust characteristics associated with the network site such that the level of monitored activity associated with the network site approaches the acceptable level of activity associated with the network site.

The present invention provides the advantage of increasing the effectiveness of a network site.

The present invention further provides the advantage of automatically adjusting characteristics associated with a network site such that an increase in activity associated with the network site is achieved.

The present invention also provides the advantage of maintaining effectiveness of a network site by comparing a monitored level of activity associated with the network site to a level of activity associated with the network site determined to be acceptable and by further adjusting characteristics associated with the network site such that the monitored level of activity associated with the network site approaches the level of activity associated with the network site determined to be acceptable.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 illustrates a block diagram showing a computer system according to a preferred embodiment of the present invention;

FIG. 2 illustrates the graphical user interface (GUI) of a computer's operating system typically employed on a computer system as in FIG. 1, according to the preferred embodiment of the present invention;

FIG. 3 illustrates a computer network according to the preferred embodiment of the present invention;

FIG. 4 illustrates a high level flow diagram of a method according to the preferred embodiment of the present invention;

FIG. 5A illustrates the GUI of a web browser displaying a product oriented web page according to the preferred embodiment of the present invention; and

FIG. 5B illustrates the GUI of a web browser displaying an advertising oriented web page according to the preferred embodiment of the present invention.

### DETAILED DESCRIPTION OF A PREFERRED EMBODIMENT OF THE INVENTION

In the following detailed description of the preferred embodiment and other embodiments according to the present invention, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

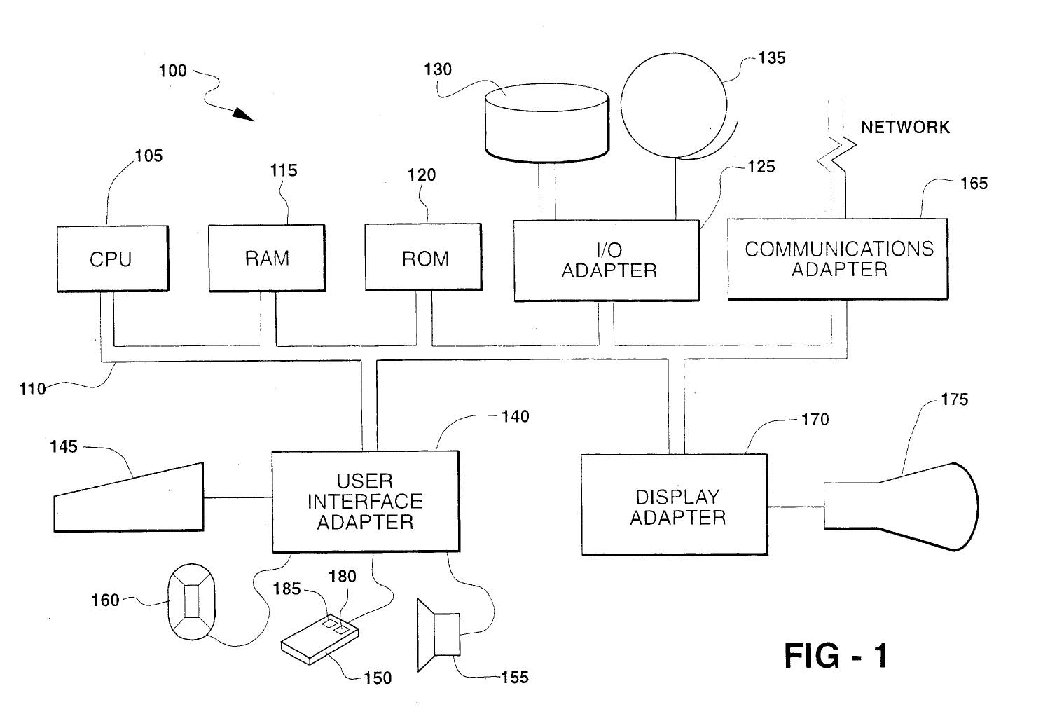

A representative hardware environment for practicing the present invention is depicted in FIG. 1, which illustrates a typical hardware configuration of an information handling system 100 in accordance with the present invention, having a central processing unit 105 such as a conventional microprocessor and a number of other units interconnected via at least one system bus 110. Information handling system 100 may be, for example, a portable or desktop IDOT.COM computer. Information handling system 100 shown in FIG. 1 includes random access memory (RAM) 115, read-only memory (ROM) 120, and input/output (I/O) adapter 125 for connecting peripheral devices such as disk units 130 and tape drives 135 to system bus 110, a user interface adapter 140 for connecting keyboard 145, mouse 150, speaker 155, microphone 160, and/or other user interface devices to system bus 110, communications adapter 165 for connecting information handling system 100 to an information network such as the Internet, and display adapter 170 for connecting system bus 110 to a display device such as monitor 175. Mouse 150 has a series of buttons, right button 180 and left button 185, and is used to control a cursor (not shown) on monitor 175.

Although many of today's televisions employ much of the same hardware resources employed by computers such as information handling system 100, it is possible that the present invention might be practiced in other electronic devices or in networked electronic devices. For example, with the development of audio/video networking standards, such as the recently proposed HAVi (Home Audio-Video interoperability) standard, television sets or other audio/video devices such as audio/video receivers and VCRs that do not themselves contain resources similar to information handling system 100 could implement the present invention by utilizing the resources of other devices on a network.

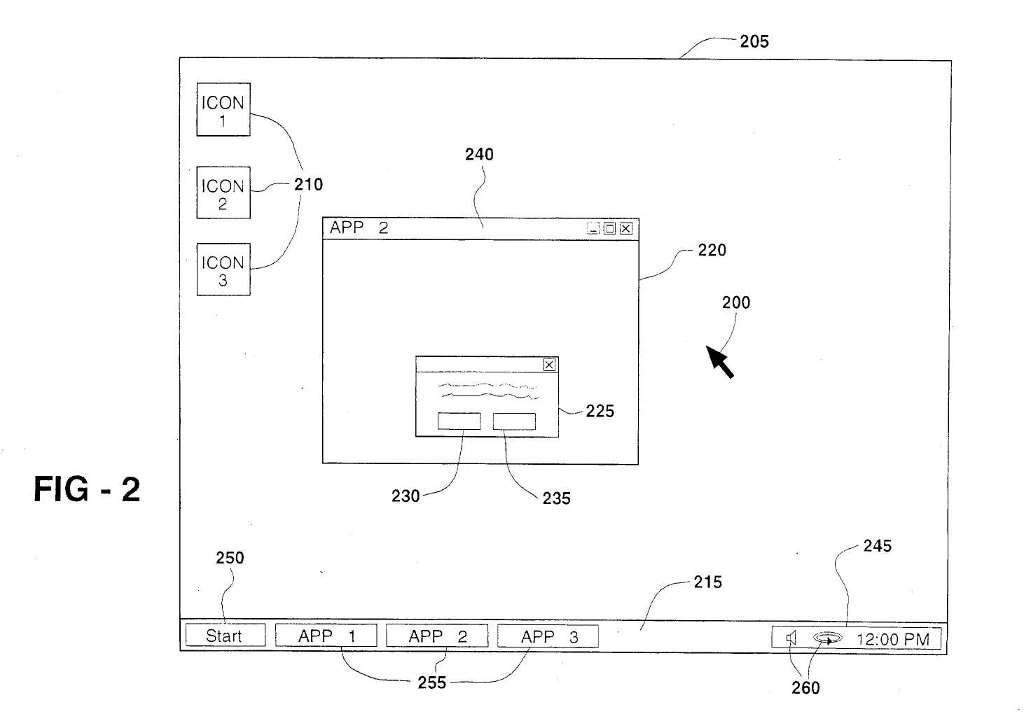

Referring next to FIG. 2, a graphical user interface, or GUI, of an operating system as is typically displayed on monitor 175 as illustrated in FIG. 1, in accordance with the present invention, is illustrated. Reference numerals or letters in FIG. 2 which are like, similar, or identical to the reference numerals or letters of FIG. 1 indicate like, similar, or identical components or features. The operating system GUI shown in FIG. 2 is Windows 98/95 (Windows 98/95 are trademarks of Microsoft Corporation); however, the present invention will work with OS/2 or any other operating system (OS/2 is a trademark of International Business Machines Corporation). This GUI depicted in FIG. 2 comprises cursor 200, desktop 205, icons 210, window 220, task bar 215, and dialog box 225, all of which are well known in the art. Task bar 215 further contains “Start” button 250, open applications buttons 255, and system tray 245 which is further comprised of open application icons 260, all of which are well known in the art. Dialog box 225 further contains two buttons, button one 230 and button two 235. Programs, i.e., software applications, are represented by the graphical user interface as either icons 210, open application buttons 255, or program windows 220. The horizontal region along the top of program window 220 is called the “title bar” 240. Program window 220 has the “focus” when it has been designated by the user or by the operating system to receive input from keyboard 145, mouse 150 as illustrated in FIG. 1, or other input device. In Windows 98/95, the user gives the window focus by clicking a mouse button such as right button 180 or left button 185, as illustrated in FIG. 1, when cursor 200 is inside program window 220. Some operating systems, however, give program window 220 the focus merely when cursor 200 is present within program window 220. The operating system can indicate which program has the focus by changing the color of the title bar 240 of focused program window 220.

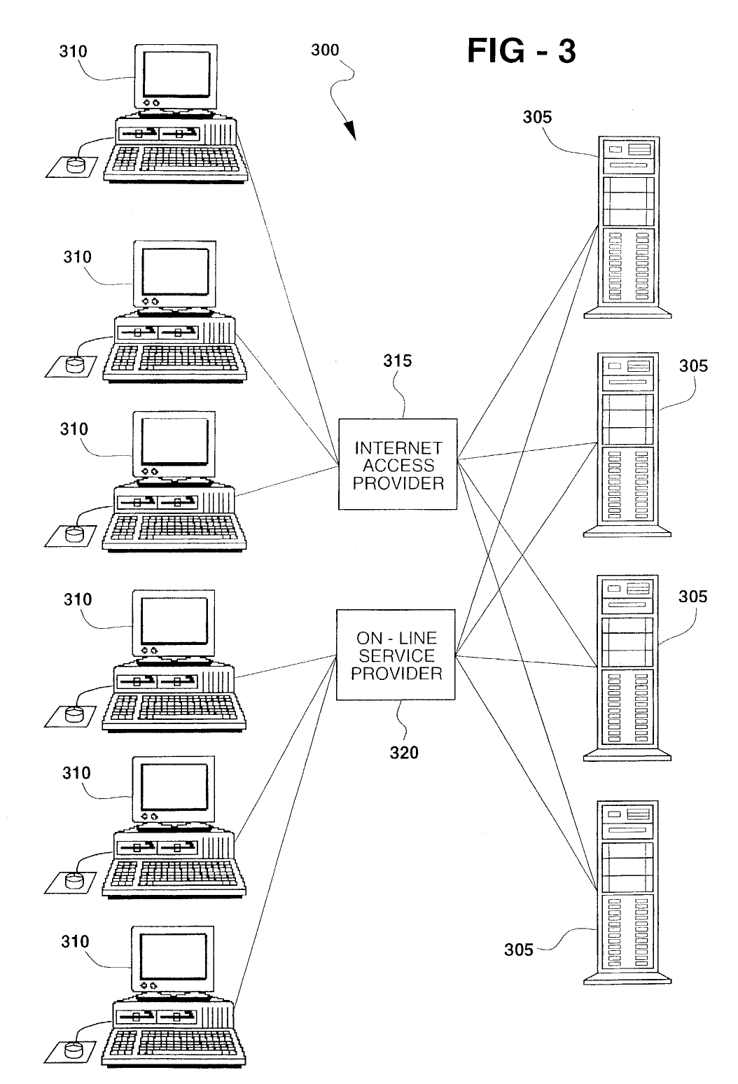

Referring now to FIG. 3, a computer network as indicated generally at 300, according to the preferred embodiment of the present invention, is illustrated. Reference numerals or letters in FIG. 3 which are like, similar, or identical to the reference numerals or letters of FIGS. 1-2 indicate like, similar, or identical components or features. Computer network 300 is representative of a remote network, such as the Internet. Conceptually, the Internet includes a large network of servers 305 which are accessible by clients 310, typically users of information handling systems 100, as illustrated in FIG. 1. Information handling systems 100, as illustrated in FIG. 1 typically access server 305 via an Internet service provider (ISP) 315 or an on-line service provider 320. Each client 310 may run a web browser, a well known software application utilized to access and display web site pages, or documents, available via the Internet as is known in the art. Server 305 stores and operates a web site which supports files in the form of documents and pages as well as others formats known in the art. A network path to server 305 can be identified by a universal resource locator (URL), or hyperlink, having a known syntax for defining a network collection. Computer network 300 is merely illustrative, and it will be appreciated by persons skilled in the art that any working configuration or future configuration thereof can be utilized to implement the present invention. New communication configurations or protocols, therefore, will not part from the scope of the present invention.

The present invention, in its preferred embodiment, is implemented as a program of instructions to be executed via the resources of information handling system 100 as illustrated in FIG. 1, server 305 as illustrated in FIG. 3, or similarly enabled device. Therefore, the following description assumes this program of instructions implementation. As can be appreciated by persons having ordinary skill in the art, many different program modules and many different sequences of programming code can be implemented to achieve the functions disclosed herein. It is also possible to generate hardware specific coding to allow for the optimization of specific hardware resources. With this in mind, the following description avoids discussing any specific sequences of code. The detailed description herein discloses the functions by which the present invention, in its preferred embodiment, can be practiced.

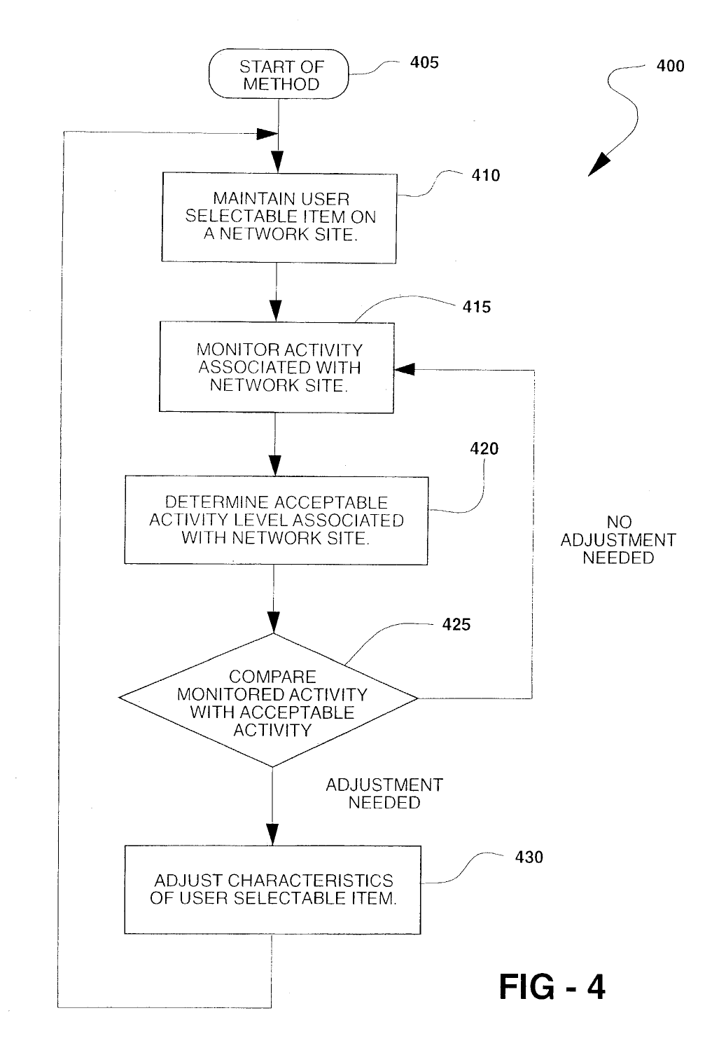

In the preferred embodiment, the present invention is employed and implemented with an electronic commerce enabled web site and utilizes the method indicated generally at 400 as illustrated in FIG. 4. Reference numerals or letters in FIG. 4 which are like, similar, or identical to the reference numerals or letters of FIGS. 1-3 indicate like, similar, or identical components or features. An electronic commerce enabled web site is a web site that is configured to facilitate financial transactions between parties, i.e., buying and/or selling products or services. Before discussing some of the characteristic steps of the preferred embodiment of the present invention, it is first necessary to take a higher level look at the goals of method 400.

Method 400 can be utilized to increase the efficiency of an electronic commerce enabled web site. However, it can also be utilized to increase the efficiency of a polling web site or any other demand driven web sites. Demand driven web sites are web sites which garner their revenues based upon the number of visitors to a web site. Method 400 increases the efficiency of a web site by first monitoring the activity associated with the web site and/or activity associated with at least one user selectable item maintained therein and then comparing these activity levels with an acceptable level of activity.

The user selectable item, typically configured as a hyperlink, can provide selection of an item offered for sale, an advertisement for poll participants, or other user selectable item commonly known to persons of ordinary skill in Internet concepts. Upon finding differences between the monitored activity level and the acceptable activity level, method 400 determines and then implements adjustments to characteristics associated with the web site and/or the user selectable item maintained therein such that the monitored activity level approaches the acceptable activity level.

Possible adjustments include, but are not limited to, changing a displayed advertisement, raising or lowering a price associated with an item offered for sale, or changing some other characteristic associated with the user selectable item, web site configuration, or the network location of a web site. The changes implemented can have a goal of increasing visitors to a particular web site, or in the case of an overloaded server 305, the goal can be decreasing the number of visitors to a web site.

Method 400 begins at step 405 after which the method proceeds directly to step 410. The main objective of step 410 is to make at least one user selectable item available on a web site. To accomplish this goal of making at least one user selectable item available on a web site, step 410 can create and/or display an entire web site. Typically the data associated with an entire web site comprises the Hypertext Markup Language (HTML) which formats the presentation of a web page, the text displayed in the web page, images inserted into the web page, as well as other components. Alternatively, step 410 can display an advertisement, such as an image containing product and pricing information, within a web site comprised of many advertisements. Once at least one user selectable item or and/or web site has been created and/or displayed by step 410, method 400 of the preferred embodiment of the present invention progresses to step 415. Web page design utilizing HTML as well as other methods can be appreciated by persons having ordinary skill in the art. Therefore, the details of web page creation, generation, configuration, etc., have been omitted herein.

Next, step 415 monitors at least one of the many different variables related to the activity associated with a web site and/or a user selectable item. For example, step 415 can keep track of the number of visitors to a product or services web site. Further, step 415 can monitor how many of those web site visitors select each of the products, services, or inquire into additional information provided by a product or services web site. The specific variable to be monitored depends directly on the intended use of the variable, and as can be appreciated by persons having ordinary skill in the art, many different variables can be monitored and used in many different ways to provide data which can aid market research. Examples of monitored activity include the number of visitors to a particular web site, the number of visitors to a particular web site who request information, the number of web site visitors who purchase an item provided within the web site, the amount of time a web site visitor spends at the web site, etc. Once a monitored activity level has been determined by step 415, method 400 progresses to step 420.

Next, as illustrated by step 420, acceptable levels of activity associated with a particular web site and/or activity associated with a user selectable item maintained within a web site is determined. An acceptable level of activity can be a fixed number of expected visitors to a targeted web site, or this determined acceptable level of activity can be generated via a complex economic model which takes into consideration the time of day, the number of web site visitors, the product being offered, the time of year (such as the Christmas season), etc. The methods of determining an acceptable level of activity can vary widely depending on the utilization goals associated with the web site and the desired efficiency associated with the web site. Once an acceptable level of activity has been determined, method 400 proceeds to step 425.

Next, step 425 compares the difference between the acceptable level of activity associated with the web site and the monitored level of activity associated with the web site. Depending on the desired detail of the monitored level of activity and the acceptable level of activity associated with a web site, step 425 can include taking the difference between the activity levels, or in the case of a desire for more detailed values for monitored activity and for the acceptable level of activity, the complexity of step 425 can become virtually limitless. As can be appreciated by persons skilled in the art of economic modeling, many different methods of attempting to increase, decrease, or otherwise alter the response, i.e., activity, of consumers to an advertised product, product on sale, service, or poll accessible from a web site can be envisioned. Upon comparison of the monitored activity to the acceptable level of activity, step 425 determines whether or not to progress to step 430 or to begin the method again by returning to step 410. If a predetermined difference between the monitored activity and the acceptable level of activity is determined to exist, the method returns to step 415. If a significant difference between the monitored activity and the acceptable level of activity is determined to exist, the method proceeds to step 430 for web site characteristic adjustment implementation.

Next, step 430 adjusts the contents of the web site and/or the user selectable item displayed therein such that the monitored activity associated with a web site approaches the acceptable level of activity associated with a web site. Adjustments to the user selectable item can include lowering or raising the price associated with an item for sale or changing a characteristic associated with an item for sale such as color, attachments, configurations, etc. Adjustments to the web site can include, but are not limited to, changes to content associated with the web site, changing a displayed graphic designed to draw visitors to a web site, or other change as can be appreciated by persons of ordinary skill in the art of web site design.

The adjustment to be made to the user selectable item can be determined by consulting a popularity database for a more desirable graphic and/or by consulting a pricing model based upon web site visitation, as well as a limitless array of other recommendation options. Upon determining the recommended adjustment, the method then progresses to step 410 for implementation of characteristic adjustment and a reiteration of the method. Method 400 can be implemented such that web site activity is continuously monitored, or method 400 can be designed such that web site activity is monitored periodically. Although only a few embodiments are disclosed herein, other embodiments which adjust web site location, web site content, etc., do not part from the scope of the present invention.

Method 400 can be further configured with a “stop” step (not shown) accessible from any step via a common escape routine or equivalent means, enabling an operator of an electronic commerce enabled web site to end the method when and as desired.

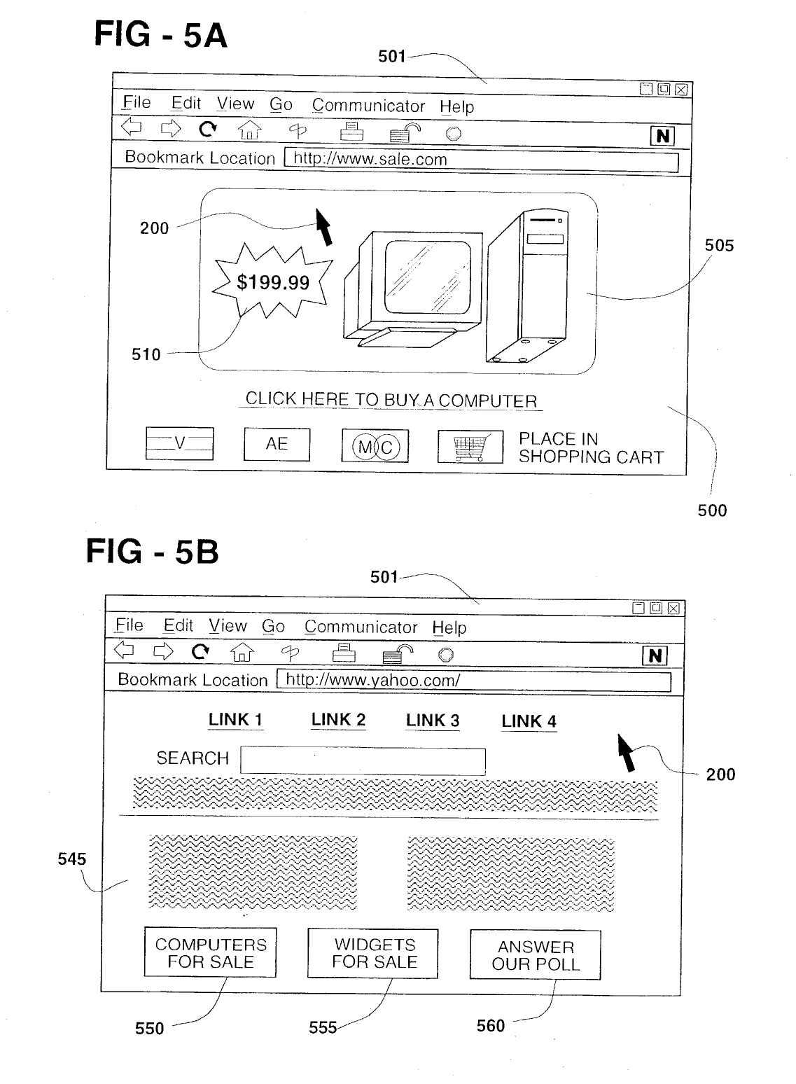

Referring next to FIG. 5A, a GUI of a web browser accessing an electronic commerce enabled web site is illustrated according to the preferred embodiment of the present invention. Reference numerals or letters in FIG. 5A which are like, similar, or identical to the reference numerals or letters of FIGS. 1-4 indicate like, similar, or identical components or features. FIG. 5A contains an illustration of a GUI web browser window 501 displaying a web page. Web page 500 in FIG. 5A is an illustration of an electronic commerce enabled web site. The user selectable item or item offered for sale in web page 500 is a computer illustrated by graphic 505. The computer offered for sale via graphic 505 is offered at the price indicated by explosion balloon 510. According to the preferred embodiment of the present invention, explosion balloon 510 can be adjusted such that the entity offering the item for sale can attempt to control the sales volume of the item offered for sale.

If requests for information associated with the web site are being received from web site visitors, also known as hits or visitations, but very few of the web site visitors are purchasing the item offered for sale, the present invention may choose to lower the price displayed in explosion balloon 510 such that an increase in sales volume results. In an alternate embodiment, the price in explosion balloon 510 is increased if the item illustrated by graphic 505 is selling too fast, i.e., has a high sales volume. There are many different goals that can be achieved by the “active price adjusting method” of the present invention. For example, it would be highly desirable for a seller of products or services to be able to increase the price of a product or service without affecting sales volume. The active price adjusting method can also facilitate adjusting the sales price of a product or service such that an optimal price is obtained.

Referring now to FIG. 5B, a GUI which displays a web browser window 501 displaying a web page, according to the preferred embodiment of the present invention, is illustrated, containing first user selectable item 550, second user selectable item 555, and third user selectable item 560 therein. Reference numerals or letters in FIG. 5B which are like, similar, or identical to the reference numerals or letters of FIGS. 1-5A indicate like, similar, or identical components or features. The present invention, in this embodiment, can access the number of hits or visitations received by web site 545. If an undesirable percentage of visitors access web site 545 without selecting first user selectable item 550, second user selectable item 555, and/or third user selectable item 560, the present invention can adjust the characteristics of web site 545, such as the advertisement associated with first user selectable item 550, second user selectable item 555, or third user selectable item 560, in such a way that the percentage of visitors to web site 545 which select first user selectable item 550, second user selectable item 555, and/or third user selectable item 560 increases. Adjustments which can be made include, but are not limited to, changing the graphics associated with an advertisement, changing the wording of an advertisement, etc.

In summary, the preferred embodiment of the present invention maintains at least one user selectable item at a network location or web site. The present invention then monitors activity associated with the user selectable item and/or the web site. Upon the determining an acceptable level of activity associated with the web site and/or the user selectable item, a comparison is performed between the monitored level of activity and the acceptable level of activity. If an undesirable difference in activity levels results, an adjustment to the user selectable item and/or the web site is performed prior to the reiteration of the method of the present invention.

A preferred embodiment of the present invention is designed for use in an electronic commerce enabled web site wherein the user selectable item is typically a product or service for sale and the activity of interest is sales volume. In order to adjust sales volume to an appropriate level, the price associated with the product or service offered for sale is one of the characteristics which can be adjusted.

Although an embodiment of the present invention has been shown and described in detail herein, along with certain variants thereof, many other varied embodiments that incorporate the teachings of the invention may be constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

Although the invention has been described with a certain degree of particularity, it should be recognized that elements thereof may be altered by persons skilled in the art without departing from the spirit and scope of the invention. One of the preferred implementations of the invention is as sets of instructions resident in the random access memory 115 of one or more computer or information handling systems configured generally as described in FIGS. 1-5B. Until required by the computer system, the set of instructions may be stored in another computer readable memory, for example, in a hard disk drive or in a removable memory such as an optical disk for eventual use in a CD-ROM drive or a floppy disk for eventual use in a floppy disk drive.

Further, the set of instructions can be stored in the memory of another computer or encoded or embodied in a signal, such as an analog or digital signal, embodied in a propagation medium and transmitted over the propagation medium by a user. The propagation medium may include a local area network or a wide area network, such as the Internet, or other propagation medium. One skilled in the art will appreciate that the physical storage or encoding of the sets of instructions physically changes the medium upon which it is stored or encoded electrically, magnetically, or chemically so that the medium carries computer readable instructions and other information. The invention is limited only by the following claims and their equivalents.

We claim:

1. A method to increase effectiveness of a networked site comprising the steps of:
maintaining at least one user selectable item on a network site, the user selectable item having at least one characteristic;
monitoring activity associated with the network site; and
automatically adjusting the at least one characteristic in response to the step of monitoring activity associated with the network site such that a change in activity associated with the network site can be achieved.

2. The method, as defined in claim 1, further comprising the steps of:
determining an acceptable activity level associated with the network site; and
comparing the monitored activity associated with the network site to the determined acceptable activity level associated with the network site.

3. The method, as defined in claim 2, wherein the step of automatically adjusting the at least one characteristic further includes adjusting the at least one characteristic until the monitored activity associated with the network site approaches the determined acceptable activity level associated with the network site.

4. The method, as defined in claim 1, wherein the at least one user selectable item further includes a saleable item.

5. The method, as defined in claim 1, wherein the at least one characteristic further includes a sales price.

6. The method, as defined in claim 1, wherein activity associated with the network site further includes sales volume.

7. The method, as defined in claim 1, further comprising the step of:
facilitating financial transactions.

8. The method, as defined in claim 1, wherein the at least one user selectable item further includes an advertisement.

9. The method, as defined in claim 1, wherein the at least one characteristic further includes an image.

10. The method, as defined in claim 1, wherein activity associated with the network site further includes requests for information associated with the network site.

11. A computer readable medium tangibly embodying a program of instructions implementing a method to increase effectiveness of a networked site comprising the steps of:
maintaining at least one user selectable item on a network site, the user selectable item having at least one characteristic;
monitoring activity associated with the network site; and
automatically adjusting the at least one characteristic in response to the step of monitoring activity associated with the network site such that a change in activity associated with the network site can be achieved.

12. The computer readable medium, as defined in claim 11, further comprising the steps of:
determining an acceptable activity level associated with the network site; and
comparing the monitored activity associated with the network site to the determined acceptable activity level associated with the network site.

13. The computer readable medium, as defined in claim 12, wherein the step of automatically adjusting the at least one characteristic further includes adjusting the at least one characteristic until the monitored activity associated with the network site approaches the determined acceptable activity level associated with the network site.

14. The computer readable medium, as defined in claim 11, wherein the at least one user selectable item further includes a saleable item.

15. The computer readable medium, as defined in claim 11, wherein the at least one characteristic further includes a sales price.

16. The computer readable medium, as defined in claim 11, wherein activity associated with the network site further includes sales volume.

17. The computer readable medium, as defined in claim 11, further comprising the step of:
facilitating financial transactions.

18. The computer readable medium, as defined in claim 11, wherein the at least one user selectable item further includes an advertisement.

19. The computer readable medium, as defined in claim 11, wherein the at least one characteristic further includes an image.

20. The computer readable medium, as defined in claim 11, wherein activity associated with the network site further includes requests for information associated with the network site.

21. A signal embodied in a propagation medium configured to increase effectiveness of a networked site comprising:
at least one instruction configured to maintain at least one user selectable item on a network site, said user selectable item having at least one characteristic;
at least one instruction configured to monitor activity associated with said network site; and
at least one instruction configured to automatically adjust said at least one characteristic in response to the said at least one instruction configured to monitor activity associated with said network site such that a change in activity associated with said network site can be achieved.

22. The signal, as defined in claim 21, further comprising:
at least one instruction configured to determine an acceptable activity level associated with said network site; and
at least one instruction configured to compare said monitored activity associated with said network site to said determined acceptable activity level associated with said network site.

23. The signal, as defined in claim 22, wherein said at least one instruction configured to automatically adjust said at least one characteristic further includes at least one instruction configured to adjust said at least one characteristic until said monitored activity associated with said network site approaches said determined acceptable activity level associated with said network site.

24. The signal, as defined in claim 21, wherein said at least one user selectable item further includes a saleable item.

25. The signal, as defined in claim 21, wherein said at least one characteristic further includes a sales price.

26. The signal, as defined in claim 21, wherein activity associated with said network site further includes sales volume.

27. The signal, as defined in claim 21, further comprising:
at least one instruction configured to facilitate financial transactions.

28. The signal, as defined in claim 21, wherein said at least one user selectable item further includes an advertisement.

29. The signal, as defined in claim 21, wherein said at least one characteristic further includes an image.

30. The signal, as defined in claim 21, wherein activity associated with said network site further includes requests for information associated with said network site.

31. A user interface configured to:
maintain at least one user selectable item on a network site, said user selectable item having at least one characteristic;
monitor activity associated with said network site; and
automatically adjust said at least one characteristic in response to said monitored activity associated with said network site such that a change in activity associated with said network site can be achieved.

32. The user interface, as defined in claim 31, further configured to:
determine an acceptable activity level associated with said network site; and
compare said monitored activity associated with said network site to said determined acceptable activity level associated with said network site.

33. The user interface, as defined in claim 32, further configured to adjust said at least one characteristic until said monitored activity associated with said network site approaches said determined acceptable activity level associated with said network site.

34. The user interface, as defined in claim 31, wherein said at least one user selectable item further includes a saleable item.

35. The user interface, as defined in claim 31, wherein said at least one characteristic further includes a sales price.

36. The user interface, as defined in claim 31, wherein activity associated with said network site further includes sales volume.

37. The user interface, as defined in claim 31, further configured to:
facilitate financial transactions.

38. The user interface, as defined in claim 31, wherein said at least one user selectable item further includes an advertisement.

39. The user interface, as defined in claim 31, wherein said at least one characteristic further includes an image.

40. The user interface, as defined in claim 31, wherein activity associated with said network site further includes requests for information associated with said network site.

41. An information handling system comprising:
at least one processor;
memory operably associated with said processor;
at least one communications adapter operably associated with said processor and said memory; and
a user interface configured to:
maintain at least one user selectable item on a network site, said user selectable item having at least one characteristic;
monitor activity associated with said network site; and
automatically adjust said at least one characteristic in response to said monitored activity associated with said network site such that a change in activity associated with said network site can be achieved.

42. The information handling system, as defined in claim 41, wherein said user interface is further configured to:
determine an acceptable activity level associated with said network site; and
compare said monitored activity associated with said network site to said determined acceptable activity level associated with said network site.

43. The information handling system, as defined in claim 42, wherein said user interface is further configured to adjust said at least one characteristic until said monitored activity associated with said network site approaches said determined acceptable activity level associated with said network site.

44. The information handling system, as defined in claim 41, wherein said at least one user selectable item further includes a saleable item.

45. The information handling system, as defined in claim 41, wherein said at least one characteristic further includes a sales price.

46. The information handling system, as defined in claim 41, wherein activity associated with said network site further includes sales volume.

47. The information handling system, as defined in claim 41, wherein said user interface is further configured to:
facilitate financial transactions.

48. The information handling system, as defined in claim 41, wherein said at least one user selectable item further includes an advertisement.

49. The information handling system, as defined in claim 41, wherein said at least one characteristic further includes an image.

50. The information handling system, as defined in claim 41, wherein activity associated with said network site further includes requests for information associated with said network site.
